(19) United States
(12) Patent Application Publication
(10) Pub. No.: US 2010/0257944 A1
(43) Pub. Date: Oct. 14, 2010

(54) TORQUE SENSOR ADJUSTABLE PLATFORM APPARATUS AND METHOD

(75) Inventors: Prem Anand Ramalingam, Tamil adu (IN); Max C. Jarrell, Fenton, MI (US)

Correspondence Address: HONEYWELL/CST;Patent Services, 101 Columbia Road, P.O. Box 2245, Morristown, NJ, 07962-2245, US

(73) Assignee: Honeywell International Inc.

(21) Appl. No.: 12/421,223

(22) Filed: Apr. 9, 2009

(51) Int. Cl. G01L 5/24

(52) U.S. Cl. 73/862.21

(57) ABSTRACT

A torque sensor adjustable platform apparatus is configured to include a base with a centering block between two linear grooves. Two sliders slide along the linear grooves under the control of a lead screw. Turning the lead screw causes the sliders to either approach each other or to separate. A PCB tray rides on top of the sliders. The tops of the sliders have retaining grooves keyed to accept retaining rails on the bottom of the PCB tray. The retaining grooves and retaining rails are angled so that the PCB tray moves further from the base as the sliders approach one another. A receiving module fixed into the PCB tray receives a signal from a shaft mounted torque sensor. The lead screw can be manipulated to optimizing the received signal while keeping the receiving module clear of the shaft.

### TECHNICAL FIELD

Embodiments are related to torque sensors. Embodiments are also related to digital telemetry torque systems. Embodiments are additionally related to adjustable platforms for use with torque sensors.

### BACKGROUND OF THE INVENTION

It is often advantageous to measure the torque on a shaft such as a rotating drive shaft. The torque measurement can then be input to control or monitoring systems. Wireless torque measurement systems typically have a torque sensor attached to the shaft and a signal receiver located nearby.

### BRIEF SUMMARY

The following summary is provided to facilitate an understanding of some of the innovative features unique to the embodiments disclosed and is not intended to be a full description. A full appreciation of various aspects of some embodiments can be gained by taking the entire specification, claims, drawings, and abstract as a whole.

It is therefore an aspect of some embodiments that a base has a guide block and two linear grooves on either side of the guide block. Two sliders slide in the linear grooves with one slider in each of the linear grooves. The bottom of each slider fits in and slides along a linear groove while the top of each slider has a retaining groove. The retaining groove is angled such that the end closer to the guide block is lower when the slider is properly positioned in the linear groove.

It is another aspect of some embodiments that each of the sliders has a threaded bushing fixedly attached. A lead screw passing through the guide block is threaded into each threaded bushing. The threaded bushings and the lead screw are threaded such that rotating the lead screw in one direction causes both sliders to approach the guide block. Turning the lead screw in the other direction causes both sliders to move away from the guide block.

It is a further aspect of some embodiments that a printed circuit board (PCB) tray has two retaining rails and a center slot located between the retaining rails. The retaining rails are angled to slide through and be retained by the retaining grooves. As such, the PCB tray moves away from the base when the sliders move toward the guide block. The center slot and the guide block are aligned so that the guide block fits in the center slot and thereby keeps the PCB tray centered over the base. As such, turning the lead screw adjusts the distance between the base and the PCB tray.

### BRIEF DESCRIPTION OF THE DRAWINGS

The accompanying figures, in which like reference numerals refer to identical or functionally-similar elements throughout the separate views and which are incorporated in and form a part of the specification, further illustrate embodiments and, together with the detailed description, serve to explain embodiments disclosed herein.

FIG. 1 illustrates a torque measuring system with an adjustable space between a torque sensor and a receiving module in accordance with aspects of some embodiments;

FIG. 2 illustrates the top side of the base of a torque sensor adjustable platform in accordance with aspects of some embodiments;

FIG. 3 illustrates a side view of a torque sensor adjustable platform in accordance with aspects of some embodiments;

FIG. 4 illustrates the bottom side of the base of a torque sensor adjustable platform in accordance with aspects of some embodiments;

FIG. 5 illustrates a covered torque sensor adjustable platform in accordance with aspects of some embodiments;

FIG. 6 illustrates a retention pin pulling a PCB tray toward the base of a torque sensor adjustable platform in accordance with aspects of some embodiments; and

FIG. 7 illustrates a keyed stop side slider and a keyed stop in accordance with aspects of some embodiments.

### DETAILED DESCRIPTION

The particular values and configurations discussed in these non-limiting examples can be varied and are cited merely to illustrate at least one embodiment and are not intended to limit the scope thereof.

Current mass produced systems suffer inaccuracies and signal degradation because the torque sensor and the signal receiver are too distant. This problem is particularly common in systems having a variety of shafts of different thicknesses passing through similar assemblies. Systems and methods are needed for easily adapting a mass produced torque sensing unit for use with a variety of shaft sizes and mounting variations.

A torque sensor adjustable platform has a base with a centering block between two linear grooves. Two sliders slide along the linear grooves under the control of a lead screw. Turning the lead screw causes the sliders to either approach each other or to separate. A PCB tray rides on top of the sliders. The tops of the sliders have retaining grooves keyed to accept retaining rails on the bottom of the PCB tray. The retaining grooves and retaining rails are angled so that the PCB tray moves further from the base as the sliders approach one another. A receiving module fixed into the PCB tray receives a signal from a shaft mounted torque sensor. The lead screw can be manipulated to optimizing the received signal while keeping the receiving module clear of the shaft.

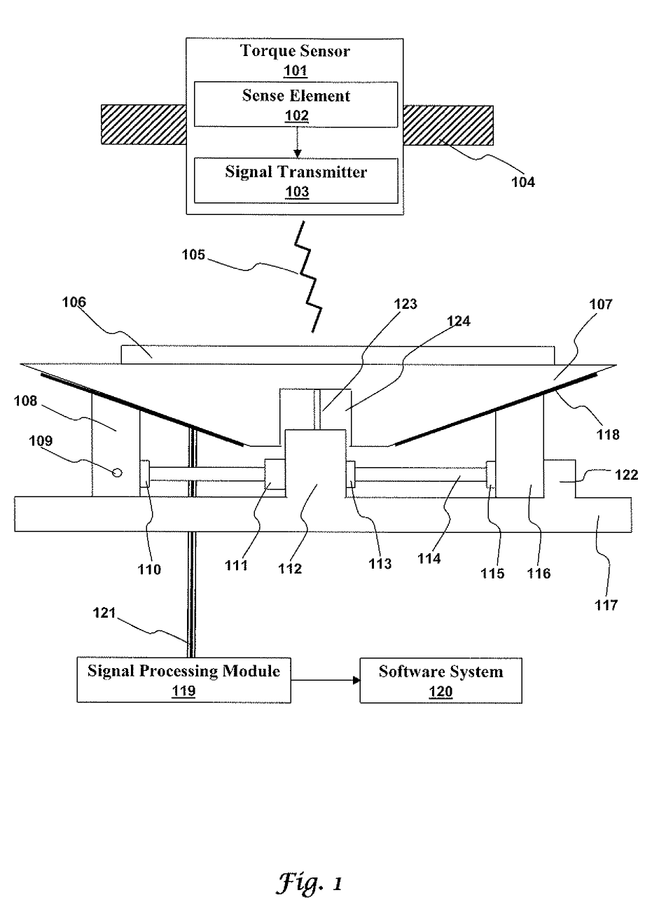

FIG. 1 illustrates a torque measuring system with an adjustable space between a torque sensor 101 and a receiving module 106 in accordance with aspects of some embodiments. The torque sensor 101 is mounted to a shaft 104 and has a sense element 102 that detects shaft torque and has a signal transmitter 103 that transmits a signal 105 to the receiving module 106. The signal 105 is a function of the sensed torque. The receiving module 106 accepts the signal 105 and passes it along interconnection wiring 121 to a signal processing module 119 that converts the signal into a torque measurement for use by a software system 120. The software system 120 can simply report the measured torque to a person, can log the measured torque for future analysis, or use the torque measurement as a control input for a machine that spins the shaft 104.

The receiving module 106 is held in a printed circuit board (PCB) tray 107. The PCB tray 107 holds properly dimensioned PCBs such as the receiving module 106. The PCB tray 107 can be pulled toward a guide block 112 by a retaining pin 123. The PCB tray has a center slot 124 that fits around the guide block 112 such that the PCB tray 107 is kept centered over a base 117. Two sliders 108, 116 push the PCB tray 107 away from the base 117. The tops of the sliders 108, 116 and the underside of the PCB tray 107 are angled such that moving the sliders 108, 116 toward the guide block 112 presses the PCB tray 107 away from the base 117. Note that a similar and essentially equivalent action can be obtained by angling the slider tops and the retaining rails in the opposite direction such that the side further from the center is closer to the base.

The open side slider 108 holds a threaded bushing 110 and the stop side slider 116 also holds a threaded bushing 115. A lead screw 114 passes through the guide block 112 and is threaded into the threaded bushings 110, 115. The lead screw 114 and the threaded bushings 110, 115 are threaded such that spinning the lead screw one way pulls the sliders 108, 116 together while spinning the lead screw 114 the other way pushes the sliders 108, 116 apart. As such, spinning the lead screw 114 also causes the PCB tray 107 to move closer to or farther from the base 117.

The guide block 112 can have a left bushing 111 and a right bushing 113 that retain, position, and support the lead screw 114 within the guide block 112. A grub screw 109 is shown threaded into a hole in the open side slider 108 and tightened to retain bushing 110 within the open side slider 108.

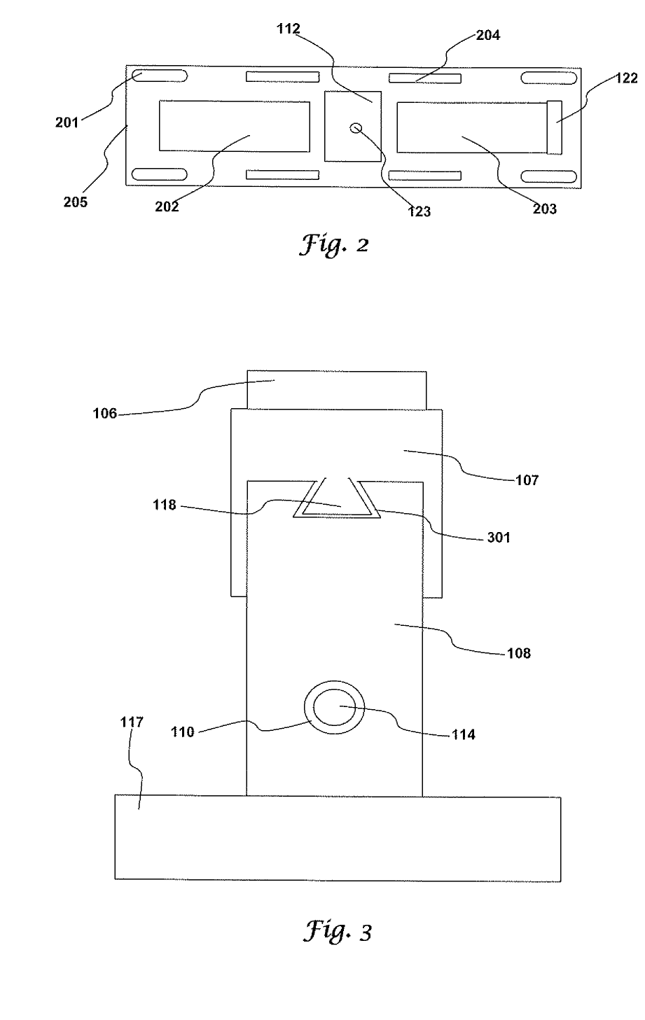

FIG. 2 illustrates the top side 205 of the base of a torque sensor adjustable platform in accordance with aspects of some embodiments. Two linear grooves 202, 203 are visible. The stop side groove 203 runs between the guide block 112 and a stop 122. The open side slot 202 is similarly position on the opposite side the guide block 112 but there is no stop on that side of the base. Mounting slots 201 and wire pass throughs 204 are also visible.

FIG. 3 illustrates a side view of a torque sensor adjustable platform in accordance with aspects of some embodiments. The receiving module 106 is fixed into the PCB tray 107 that rides on open side slider 108. A retaining groove 301 runs through the top of open side slider 108 to position and retain retaining rail 118. The retaining rail 118 is part of the PCB tray 107. The retaining rails 118 on either side of the center slot 124 run through the retaining grooves whenever a slider 108, 116 moves along a linear groove 202, 203.

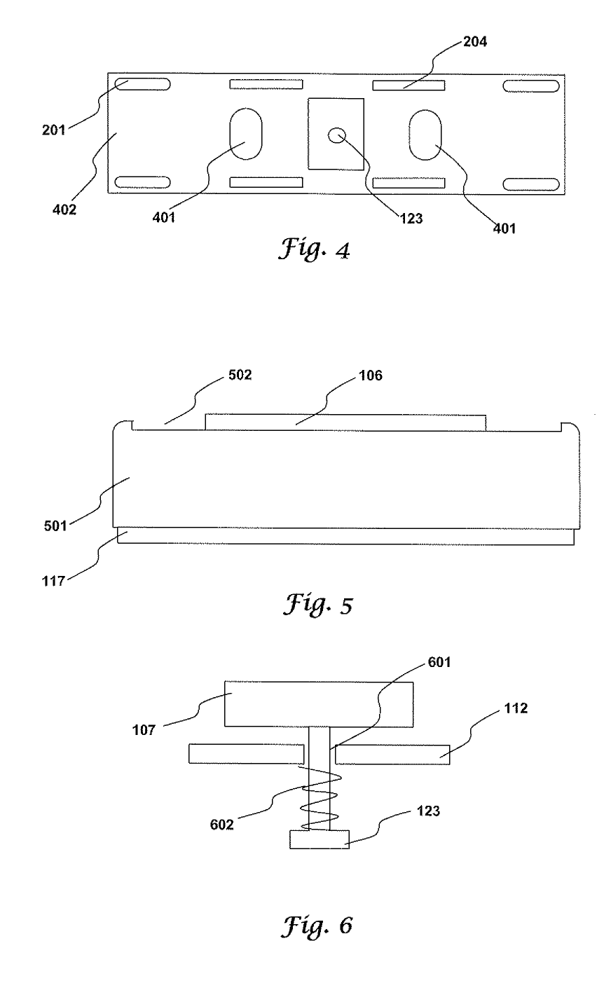

FIG. 4 illustrates the bottom side 402 of the base of a torque sensor adjustable platform in accordance with aspects of some embodiments. This view reveals two winding fixtures 401. Excess interconnect wiring can be wound around the winding fixtures 401.

FIG. 5 illustrates a covered torque sensor adjustable platform in accordance with aspects of some embodiments. A cover 501 is attached to and completely covers the torque sensor adjustable platform except for an access slot 502 through with the PCB tray 107 and receiving module 106 can pass.

FIG. 6 illustrates a retention pin 123 pulling a PCB tray 107 toward the base 117 of a torque sensor adjustable platform in accordance with aspects of some embodiments. The alignment pin 123 passed through a hole 601 in the guide block 112 and is fixedly attached to the PCB tray 107. A spring 602 pulls the PCB tray to the guide block 112 which is part of the base 117.

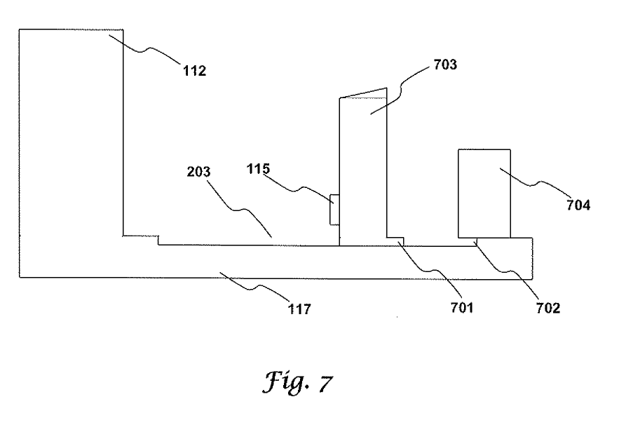

FIG. 7 illustrates a keyed stop side slider 703 and a keyed stop 704 in accordance with aspects of some embodiments. The stop side slider 703 runs through the stop side linear groove 203. When the stop side slider 703 is slid fully to the stop 704 a key 701 slips into a gap 702 to lock the slider in place. The only direction the slider can then move is along the slot and toward the guide block 112.

A torque sensor adjustable platform can be assembled by fixing the threaded bushing 115 into the stop side slider 703 and fixing right bushing 113 to the guide block 112. The stop side slider 703 is then locked against the stop 704. The lead screw 114 is passed through the right bushing 113 and threaded onto threaded bushing 115 before left bushing 111 is loosely threaded into the guide block 112. This gives the lead screw 114 some left-right play that is helpful during assembly. The retaining rail 118 on one side of the PCB tray 107 is then run into the retaining groove 301 atop the stop side slider 703. Threaded bushing 110 is then threaded onto the open side of the lead screw 114. The retaining groove 301 atop open side slider 108 is then run onto the other retaining rail 118 and positioned on the base 117. The threaded bushing 110 is then positioned into the open side slider 108 and fixed in place by tightening grub screw 109. Left bushing 111 is then tightened to remove the lead screw's 114 left-right play. The retaining pin 123 can then be positioned and attached to the PCB tray 107.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system comprising:
a base comprising two linear grooves;
two sliders each comprising a retaining groove wherein each of the sliders is positioned in a different one of the linear grooves, wherein the sliders are configured to slide in the linear grooves, and wherein the retaining grooves are angled;
two threaded bushings each fixedly attached to a different one of the sliders;
a lead screw threaded through the threaded bushings wherein the lead screw and the threaded bushings are threaded such that rotating the lead screw in a first direction pulls the sliders together wherein rotating the lead screw in the opposite direction pushes the sliders apart;
a PCB tray comprising two retaining rails and a center slot between the retaining rails wherein the retaining rails are angled to slide through and be retained by the retaining grooves such that the distance between the base and the PCB tray is adjusted by turning the lead screw;
a torque sensor fixed to a shaft that senses torque on the shaft and transmits a signal indicative of the magnitude of the torque;
a receiving module fixed to the PCB tray wherein the receiving module receives the signal and passes it to a signal processing module, and wherein rotating the lead screw adjusts the distance between the shaft and the receiver module.

2. The system of claim 1 further comprising interconnect wiring connecting the receiving module and the signal processing module, wherein the base further comprises a winding fixture, and wherein a length of the interconnect wiring is wound around the winding fixture.

3. The system of claim 2 wherein the base further comprises a wire pass through wherein the PCB tray is above the base, wherein the winding fixture is located on a base underside, and wherein the interconnect wiring passes through the wire pass through.

4. The system of claim 3 further comprising at least one grub screw positioned in at least one of the sliders such that tightening the grub screw locks the threaded bushing within the slider.

5. The system of claims 4 further comprising a cover comprising an access slot wherein the cover attaches to the base and wherein the PCB tray passes through the access slot.

6. The system of claim 1 wherein the base further comprises a wire pass through wherein the PCB tray is above the base, wherein the winding fixture is located on a base underside, and wherein the interconnect wiring passes through the wire pass through.

7. The system of claim 1 further comprising at least one grub screw positioned in at least one of the sliders such that tightening the grub screw locks the threaded bushing within the slider.

8. The system of claim 1 wherein the base further comprises a guide block centered between the linear rails, wherein the PCB tray further comprises a center slot that fits around the guide block to thereby keep the PCB tray centered over the base.

9. A system comprising:
a base comprising a stop side, an open side, a stop, a guide block, a stop side groove and an open side groove wherein the guide block is between the stop side groove and the open side groove, wherein the stop side groove runs linearly between the guide block and the stop;
a stop side slider and an open side slider each comprising a retaining groove wherein the stop side slider is positioned to slide in the stop side groove, wherein the open side slider is positioned to slide in the open side groove; and wherein the retaining grooves are angled toward the guide block;
a first threaded bushing fixedly attached to the stop side slider;
a second threaded bushing fixedly attached to the stop side slider;
a lead screw passing through the guide block and threaded through the first threaded bushing and the second threaded bushing wherein the lead screw, the first threaded bushing, and the second threaded bushing are threaded such that rotating the lead screw in a first direction causes the sliders to approach the guide block and wherein rotating the lead screw in the opposite direction causes the sliders to retreat from the guide block;
a PCB tray comprising two retained rails and a center slot between the retained rails wherein the retained rails slide through and are retained by the retaining grooves, and wherein the guide block intrudes into the center slot to keep the PCB tray centered over the base such that the distance between the base and the PCB tray is adjusted by turning the lead screw;
a torque sensor fixed to a shaft that senses a torque on the shaft and transmits a signal indicative of the magnitude of the torque;
a receiving module fixed to the PCB tray wherein the receiving module receives the signal and passes it to a signal processing module, and wherein rotating the lead screw adjusts the distance between the shaft and the receiver module.

10. The system of claim 9 further comprising interconnect wiring connecting the receiving module and the signal processing module, wherein the base further comprises a winding fixture, and wherein a length of the interconnect wiring is wound around the winding fixture.

11. The system of claim 10 wherein the base further comprises a wire pass through wherein the PCB tray is above the base, wherein the winding fixture is located on a base underside, and wherein the interconnect wiring passes through the wire pass through.

12. The system of claim 11 further comprising at least one grub screw positioned in at least one of the sliders such that tightening the grub screw locks the threaded bushing within the slider.

13. The system of claims 12 further comprising a cover comprising an access slot wherein the cover attaches to the base and wherein the PCB tray passes through the access slot.

14. A system comprising:
a base comprising two linear grooves;
two sliders each comprising a retaining groove wherein each of the sliders is positioned in a different one of the linear grooves, wherein the sliders are configured to slide in the linear grooves, and wherein the retaining grooves are angled;
two threaded bushings each fixedly attached to a different one of the sliders;
a lead screw threaded through the threaded bushings wherein the lead screw and the threaded bushings are threaded such that rotating the lead screw in a first direction pulls the sliders together wherein rotating the lead screw in the opposite direction pushes the sliders apart;
a PCB tray comprising two retaining rails and a center slot between the retaining rails wherein the retaining rails are angled to slide through and be retained by the retaining grooves such that the distance between the base and the PCB tray is adjusted by turning the lead screw; and
a retention pin passing through a hole in the base and fixedly attached to the PCB tray wherein a spring tensions the pin such that the PCB tray is pulled toward the base;
a torque sensor fixed to a shaft that senses a torque on the shaft and transmits a signal indicative of the magnitude of the torque;
a receiving module fixed to the PCB tray wherein the receiving module receives the signal and passes it to a signal processing module, and wherein rotating the lead screw adjusts the distance between the shaft and the receiver module.

15. The system of claim 14 further comprising interconnect wiring connecting the receiving module and the signal processing module, wherein the base further comprises a winding fixture, and wherein a length of the interconnect wiring is wound around the winding fixture.

16. The system of claim 15 wherein the base further comprises a wire pass through wherein the PCB tray is above the base, wherein the winding fixture is located on a base underside, and wherein the interconnect wiring passes through the wire pass through.

17. The system of claim 16 further comprising at least one grub screw positioned in at least one of the sliders such that tightening the grub screw locks the threaded bushing within the slider.

18. The system of claims 17 further comprising a cover comprising an access slot wherein the cover attaches to the base and wherein the PCB tray passes through the access slot.

19. The system of claim 1 wherein the base further comprises a guide block centered between the linear rails, wherein the PCB tray further comprises a center slot that fits around the guide block to thereby keep the PCB tray centered over the base.
